(19) United States
(12) Patent Application Publication
(10) Pub. No.: US 2006/0242214 A1
(43) Pub. Date: Oct. 26, 2006

(54) Periodicity judgement apparatus, periodicity judgement method and periodicity judgement program

(76) Inventor: Daisuke Tominaga, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/374,977

(22) Filed: Mar. 15, 2006

(30) Foreign Application Priority Data
Mar. 15, 2005 (JP) 2005-072172

(51) Int. Cl. G06F 15/00

(52) U.S. Cl. 708/200

(57) ABSTRACT

There is provided a periodicity judgment apparatus 100 to judge periodicity of time series data. A reception unit 206 receives the time series data and a set value of a period. A DFT transform unit 216 performs a Fourier transform of the time series data to obtain a Fourier coefficient vector. A Fourier coefficient adjustment unit 218 adjusts the Fourier coefficient vector to obtain plural Fourier coefficient vectors different in adjustment level. An inverse DFT transform unit 220 performs inverse Fourier transforms of the Fourier transform vectors to obtain inverse transformed data. A BIC calculation unit 228 calculates a BIC of the inverse transformed data. A periodicity judgment unit 234 judges whether a spectrum of the period of the set value is included in the Fourier coefficient vector corresponding to the inverse transformed data whose BIC is smallest. An output unit 208 outputs a judgment result of the periodicity judgment unit. By this, the periodicity of the time series data can be objectively judged.

### BACKGROUND OF THE INVENTION

1. Field of the Invention

The present invention relates to a periodicity judgment apparatus, a periodicity judgment method, and a periodicity judgment program.

2. Background

In the field of molecular biology, a change in the expression level of genes, in the activity of protein, in the quantity thereof, or the like is observed with the lapse of time, and a study is made as to whether a periodic variation is observed, or as to what period a variation has. Also in the field of social science, a variation in stock value, a variation in population composition, a variation in commodity sales in each season, or the like is observed with the lapse of time, and a study is made as to whether a periodic variation is observed, or as to what period a variation has.

As a conventional signal analyzer, there is one disclosed in, for example, JP-A-59-632. This document discloses that the signal analyzer uses, instead of using an autocorrelation coefficient near zero time difference, an autocorrelation function in an area centering on the point of time when a time difference is one pitch of a signal peak away, and finds a linear prediction coefficient, so that noise elimination is enabled, and extraction precision is improved.

However, in the signal analyzer disclosed in JP-A-59-632, there is a possibility that the analysis result becomes subjective and arbitrary. That is, in the case where the judgment of the period of a signal peak is made by this apparatus, an autocorrelation analysis is made. Thus, in order to judge the period of the signal peak, the signal peak is copied, is shifted, and is overlapped with the original signal peak itself. A correlation coefficient is calculated in a portion where the signal peak is overlapped, and when the maximum value of the correlation coefficient is sufficiently large, it is judged that the signal peak has that period.

Accordingly, in this apparatus, it is necessary to previously determine a judgment criterion as to the magnitude of the maximum value of the correlation coefficient which is sufficient to make the judgment of having a chosen period. Thus, in the signal analyzer disclosed in JP-A-59-632, since a trial and error and an empirical judgment are made in order to determine the judgment criterion, there is a possibility that the analysis result becomes subjective and arbitrary.

### SUMMARY OF THE INVENTION

The present invention has been made in view of the above circumstances, and has an object to provide a technique to objectively judge the periodicity of time series data.

According to the invention, a periodicity judgment apparatus for judging periodicity of time series data includes a time series data reception unit to receive the time series data, a period reception unit to receive a set value of a period, a Fourier transform unit to perform a Fourier transform of the time series data to obtain a Fourier coefficient vector, a Fourier coefficient vector adjustment unit to perform a simplification adjustment on the Fourier coefficient vector corresponding to the time series data by removing at least a part of Fourier coefficients included in the Fourier coefficient vector and to obtain plural adjusted Fourier coefficient vectors different in adjustment level according to degree of simplification, an inverse Fourier transform unit to perform inverse Fourier transforms of the respective plural adjusted Fourier coefficient vectors to obtain plural inverse transformed data, an information criterion calculation unit to calculate an information criterion of each of the plural inverse transformed data, a periodicity judgment unit to judge whether a spectrum of the period of the set value is included in the Fourier coefficient vector corresponding to the inverse transformed data whose information criterion is smallest, and an output unit to output a judgment result of the periodicity judgment unit.

According to the invention, since the information criterion is calculated for each of the plural inverse transformed data obtained by performing the inverse Fourier transforms of the plural adjusted Fourier coefficient vectors different in the adjustment level according to the degree of the simplification, the Fourier coefficient vector in which the information criterion is smallest or minimum can be obtained by the calculation. Thus, a trial and error, an empirical judgment or an exhaustive search to determine a judgment criterion can be reduced. As a result, the mixing of a subjective or arbitrary judgment criterion can be suppressed, and the periodicity of the time series data can be objectively judged.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 is a functional block diagram showing the whole structure of a periodicity judgment system of an embodiment.

FIG. 2 is a functional block diagram showing the inner structure of a periodicity judgment apparatus included in the periodicity judgment system shown in FIG. 1.

FIG. 3 is a functional block diagram showing the inner structures of a microarray analyzer and a scanner included in the periodicity judgment system shown in FIG. 1.

FIG. 4 is a functional, block diagram showing the inner structures of a microarray analyzer, a scanner and a server included in a modified example of the periodicity judgment system of the embodiment.

FIG. 5 is a functional block diagram showing the inner structure of a DFT transform unit included in the periodicity judgment apparatus shown in FIG. 2.

FIG. 6 is a functional block diagram showing the inner structure of a Fourier coefficient adjustment unit included in the periodicity judgment apparatus shown in FIG. 2.

FIG. 7 is functional block diagram showing the inner structures of an appropriate model judgment unit and a periodicity judgment unit included in the periodicity judgment apparatus shown in FIG. 2.

FIG. 8 is a flowchart for explaining the operation of the periodicity judgment apparatus of the embodiment.

FIG. 9 is a graph for explaining the concept of a periodicity judgment method of an embodiment.

FIG. 10 is a graph for explaining adjustment of spectral data corresponding to Fourier coefficient vectors in the periodicity judgment Method of the embodiment.

FIGS. 11A and 11B are data structural views for explaining the structure of time series data which the periodicity judgment apparatus of the embodiment receives.

FIG. 12 is a graph for explaining the concept of a cosinor method.

FIG. 13 is a graph for explaining the concept of an autocorrelation analysis.

FIGS. 14A and 14B are graphs for explaining a typical difference between spectral data corresponding to a Fourier coefficient vector of data as an object of analysis by Fourier transform in general and spectral data corresponding to a Fourier coefficient vector of biological data.

FIG. 15 is a flowchart for explaining the operation of the periodicity judgment apparatus of the embodiment.

### DETAILED DESCRIPTION

The following detailed description refers to the accompanying drawings. Although the description includes exemplary implementations, other implementations are possible and changes may be made to the implementations described without departing from the spirit and scope of the invention. The following detailed description and the accompanying drawings do not limit the invention. Instead, the scope of the invention is defined by the appended claims,

<Explanation of Research Content>

Hereinafter, embodiments of the invention will be described. In the following description, first, the invention will be described based on the research which the present inventor et al. have performed.

1) Introduction

In the field of molecular biology, a change in the expression level of genes, in the activity of a protein, in the quantity thereof, or the like is observed with the lapse of time, and a study is made as to whether a periodic variation is observed, or as to what period a variation has. The most frequent case is that a judgment is made as to whether there is a variation with 24-hour period, and a method of automating this judgment has been contrived. In the contrived method, the period is not limited to 24 hours, and arbitrary periodicity can be judged.

Materials necessary for judgment are only time series data of a judgment object and a period of periodicity to be judged. In all methods described in the following section and generally used, it is necessary to give a judgment criterion unique to each method from the outside. However, the contrived method does not require that, the arbitrariness of a person who makes a judgment is suppressed, and the objective judgment can be automated. Also in the case where the periodicity of a target period is small, that can be picked up.

2) Methods Generally Used

When certain time series data (hereinafter referred to as an original signal) is given, methods used for judging whether it has periodicity include generally four kinds of methods: a cosinor method, an autocorrelation analysis, an autoregression analysis, and a Fourier analysis. The existing methods relative to this contrived method will be described in brief below.

2.1 Cosinor Method

Cosinor method. A method in which a following model is applied to an original signal (denoted by xₜ) by the least-square method or the like, and when an approximation error is small, the model is adopted, and a judgment is made that the periodicity of the model exists also in the original signal.
xₜ=A cos(2πBt+C)+D

Where t denotes time. An approximate expression is obtained by optimizing A, B, C and D of this expression. Where, B denotes a frequency, that is, a reciprocal of a period. B is fixed to an objective frequency, A and C are optimized, and when the approximate accuracy is good, the judgment of having the period may be made. In any event, it is necessary to previously determine a level of approximation at which the model is adopted (the judgment of having the period is made). Besides, as an actual problem, unless values of A, B, C and D are estimated to some extent, the optimization can not be often performed.

2.2 Autocorrelation Analysis

Autocorrelation analysis. A method in which a correlation coefficient between an original signal and a signal obtained by shifting only the time of the original signal is calculated, and when the correlation coefficient is large, it is judged that the shift is the period of the original signal. When the shift becomes large, since the number of points for calculation of the correlation coefficient is decreased, a large period close to the length of the original signal can not be judged. A shift is increased from 0, a correlation coefficient is calculated each time, and the shift at which the correlation coefficient becomes maximum or largest can also be made the period.

Also in the autocorrelation analysis, it is necessary to previously determine a magnitude of the correlation coefficient at which the judgment of having the period is made, or an acceptable value of the correlation coefficient at the time when it is largest.

2.3 Autoregression Analysis

Autoregression analysis. A model (autoregression model) is estimated which represents a value of an original signal at time t by a linear combination of values of the original signal at n points before the time t, and the periodicity is judged from how large influence a value at a former time has on the time. The model is expressed by a following expression.
xₜ=Σ(i=1→n)cᵢxₜ₋ᵢ

Where, Σ(i=1→n)f(i) means the sum of f(i) from i=1 to i=n. The value of n can not be made very large with respect to the number of sampling points of the original signal. This model is applied to the original signal by the least-square method or the like, and in the case where the approximate accuracy is good, it is examined that the largest one of the n cᵢ is how old from the time t. A shift of time between t and cᵢ becomes a period, and when the approximate accuracy is good, it is judged that the original signal has the period.

In the autoregression analysis, in addition to the largest coefficient, a judgment can also be made that the original signal has, as a period, a time corresponding to a coefficient with a large value, and a judgment of the signal of a composite period can be made. However, also in the autoregression analysis, it is necessary to previously determine an acceptable level of the approximate accuracy, or an acceptable magnitude of the coefficient.

2.4 Fourier Analysis

Fourier analysis. Since an original signal is data in which time is discrete, a discrete Fourier transform (transform in which an obtained spectrum also becomes discrete) is applied to this, and complex Fourier coefficients the number of which is the same as the number of sampling points of the original signal are obtained. It is judged that the original signal has the period corresponding to a Fourier coefficient whose absolute value is large among the obtained Fourier coefficients.

Similarly to the foregoing autoregression analysis, although the judgment of the composite period can be made also in this method, it is also necessary to previously determine an acceptable level of the coefficient.

3) Contrived Method

As a judgment criterion, an information criterion is introduced. As a model necessary for that, a Fourier series and a normal distribution are used. By using the information criterion, setting of an index for judgment becomes unnecessary. Besides, by selecting a frequency component extracted by a discrete Fourier transform (DFT), it is possible to clarify which period component is selected.

In this method, models are formed by forming vectors in which some coefficients are replaced by 0 in a complex coefficient vector obtained by performing a discrete Fourier transform of an original signal, and a model is searched in which the number of the coefficients which are made zero is large, and a signal close to the original signal is obtained by an inverse discrete Fourier transform. Information criteria are calculated for all conceivable models, and it is judged whether the original signal has the periodicity based on whether a coefficient corresponding to a noted period is included in the model in which the information criterion is minimized. The procedure will be enumerated below.

1. The original signal is subjected to the discrete Fourier transform.

2, A search is made for a combination of some of obtained Fourier coefficients, in which the absolute values thereof are made zero and the information criterion can be minimized. In the case where the number of coefficients is large and the search takes much time, an associate optimum combination is searched by a heuristic search method. The information criterion is calculated in a following procedure.

It is determined which coefficient is made zero. When the number of coefficients is small and a calculation time is within a reasonable range, all combinations are tried.

Inverse Fourier transform is performed, and a mean square error between the obtained time series data and the original signal is calculated.

The information criterion is calculated from the number of Fourier coefficients which are not zero and the mean square error.

3. Among the Fourier coefficients which are not zero when the information criterion becomes minimum, when there is one corresponding to an objective period, it is judged that the original signal has periodicity of the period. When not, it is judged that there is no periodicity thereof.

4) Details of the Contrived Method

When there is a noted period L, it is judged whether certain time series data has periodicity of the period.

4.1 Judgment Object and Judgment Result

A judgment object is discrete points in which the number of sampling times is finite, and is time series data (hereinafter referred to as an original signal) in which an observation value is a real number. When n is an integer of 3 or more, it is defined by two n-order real number vectors including n times tᵢ(1≦i≦n) and a value xᵢ (1≦i≦n) at each tᵢ. The value xᵢ is a function of a time, is expressed by xᵢ=x(tᵢ), and is, for example, a change in the expression level of genes. In the case of n<3, a judgment of periodicity by the contrived method is not made.

After the contrived method is applied, as a judgment result, it is indicated whether the time series data has periodicity.

4.2 Algorithm

Step 1. The original signal is subjected to discrete Fourier transform.

The discrete Fourier transform is applied to the original signal, and a Fourier coefficient as an n-order complex vector is obtained. The discrete Fourier transform means that when an imaginary unit is made j, a coefficient cₖ of a following expression is obtained.
x(tᵢ)=Σ(k=1→n)cₖ exp {jk(2π/n)}

Where, Σ(k=1→n)f(k) means the sum of f(k) from k=1 to k=n.

The coefficient ck is obtained by a following expression.
cₖ=1/NΣ(i=1→n)x(tᵢ)exp {−jk(2π/n)i}

Where, Σ(i=1→n)f(i) means the sum of f(i) from i=1 to i=n.

The coefficient cₖ(1≦k≦n) is an n-order complex vector. In the case where n is even, the coefficient is cₖ=cₙ₋ₖ₊₁, and in the case where n is odd, the coefficient is cₖ=cₙ₋ₖ₊₂ (k≧2). Although the vector cₖ is the Fourier coefficient, it is also called a spectrum with respect to the original signal.

Step 2. Search is made for a model in which the information criterion is minimized.

Although there are some kinds of information criteria, it is an index to indicate a balance between the number of parameters necessary for defining a model and the reproducibility of the original signal by the model, and is a real number calculated from the model. As the number of parameters becomes small, or as the reproducibility becomes good, the information criterion has a small value, and a model in which the information criterion is made smallest or minimum is regarded as the best model. The index indicates that the model is good when it is plain, is simple, and reproduces a phenomenon with high accuracy.

The model in this case is a Fourier coefficient vector. The time series data is obtained by performing an inverse discrete Fourier transform (inverse DFT, iDFT) of the coefficient vector, and when the coefficient vector obtained from the original signal is directly subjected to the iDFT, the original signal is obtained. When some coefficients of the coefficient vector are made zero and the iDFT is performed, a signal different from the original signal is obtained. The degree of a difference from the original signal is changed by which coefficients and how many coefficients are made zero. In the case where a signal similar to the original signal is obtained even if many coefficients are made zero, it can be regarded that the original signal can be reproduced by few coefficients.

The following is performed for i of from 1 to N. N denotes an integer smaller than n, and is a value of about 2(n/2)^{1/2}.

(a) The following is performed for all combinations in which i coefficients are selected from n coefficients. When a selected coefficient is made ck at the time of selection, cₙ₋ₖ₊₁ is not selected when n is even, and cₙ₋ₖ₊₂ is not selected when n is odd. Among models obtained by a following method, a model in which the information criterion becomes smallest is made the best model.

(b) When n becomes large, since the number of ways of selection becomes an enormous number, in the case where a processing time by a calculator is not realistic, the information criterion calculated by a following method is made an objective function, a heuristic search method such as a genetic algorithm is applied to obtain an associate optimum solution, and it is made the best model.

i) In the coefficient vector obtained from the original signal, the i selected coefficients are made zero. At the same time, when the selected coefficient is made cₖ, cₙ₊ₖ₊₁ is also made zero when n is even, and cₙ₋ₖ₊₂ is also made zero when n is odd.

ii) The coefficient vector in which i coefficients become zero is subjected to the inverse discrete Fourier transform.

iii) The information criterion is calculated from the obtained signal and the original signal, and the number (p=n−2i) of coefficients which are not zero. For example, in the Akaike's information criterion (AIC), the information criterion is
AIC=n log 2π+n log σ⁻2+n+2(p+1)

Where, σ⁻ a means a symbol where ⁻ is positioned above σ.

In the case of the Bayesian information criterion (BIC), calculation 18 made in accordance with
BIC=n log 2π+n log σ⁻2+n+(p+1)log n.
Here, σ denotes the mean square error between the original signal and the signal obtained by the inverse discrete Fourier transform, and when the signal obtained by the inverse discrete Fourier transform is x⁻ᵢ, it is obtained by a following expression.
π=1/nΣ(i=1→n)(xᵢ−x⁻ᵢ)²

Incidentally, x⁻ᵢ means a symbol in which ³¹ is positioned above xᵢ.

Step 3. Judgment is made.

It is checked whether a Fourier coefficient corresponding to the noted period is included in the best model. If included, a judgment of having periodicity of the period is made, and if not included, a judgment of not having is made.

5) Specific Example

5.1 Judgment Object

Gene expression data obtained by DNA microarray is assumed. An observation is started after 12 hours from the start of the experiment, data is obtained 12 times at intervals of 4 hours, and time series data for 44 hours is made an original signal. Accordingly, the original signal is a 12-order real number vector.

5.2 Example Judged to Have Periodicity

5.2.1 Preparation of Data

It is assumed that the following original signal is desired to be judged. This is such that the expression intensity of a gene is observed at intervals of 4 hours, and the sampling time is such that t=0 indicates 12 hours after the start of the experiment, t=1 indicates 16 hours, and t=2 indicates 20 hours.
X(t)=(0.2466, 0.2592, 0.3861, 0.4785, 0.1748, 0.0776, 0.3137, 0.2497, 0.3972, 0.4654, 0.2951, 0.039)

The original signal is the 12-order real number vector, and the total observation time is 44 hours. Even if 44 hours is divided by an integer, 24 hours is not obtained. Thus, 0 is added to the front and back of the original signal by a method called zero-padding, so that the total observation time is divisible by 24.
x(t)=(0, 0, 0, 0.2466, 0.2592, 0.3861, 0.4785, 0.1748, 0.0776, 0.3137, 0.2497, 0.3972, 0.4654, 0.2951, 0.039, 0, 0, 0, 0)

By adding three 0 to the front and four 0 to the back, the total observation time becomes 72 hours, and becomes integer times (three times) of 24. By this, a coefficient corresponding to a 24-hour period is obtained by the iDFT. Hereinafter, this x(t) is made the original signal.

5.2.2 Discrete Fourier Transform

When the DFT is applied to the original signal x(t), a following Fourier coefficient is obtained. It is a 12-order complex vector.
c(f)=(3.3836. −1.5543−0.6156i, −0.5312−0.6937i, 0.3880+1.0122i, −0.0641−0.1025i, −0.2024−0.1692i, 0.4449+0.3820i, 0.0214−0.3824i, −0.1293+0.0117i, −0.0647−0.1671i, −0.0647+0.1671i. −0.1293-0.0117i, 0.0214+0.3824i. 0.4449−0.3820i. −0.2024+0.1692i, −0.0641+0.1025i, 0.3880−1.0122i, −0.5312+0.6937i, −1.5543+0.6156i)

A 12-order real number vector in which the absolute values of the respective complex numbers are calculated is a following spectrum.
s(f)=(0.6026, 0.1471, 0.0402, 0.0618, 0.0008, 0.0037, 0.0181, 0.0077, 0.0009, 0.0017, 0.0017, 0.0009, 0.0077, 0.0181, 0.0037, 0.0008, 0.0618, 0.0402, 0.1471)

Coefficients of the spectrum are replaced by 0 one by one in ascending order of coefficient, and when the inverse Fourier transform is performed each time and the BIC is calculated in accordance with the foregoing expression, the value of the BIC is changed as follows.

| number of | |
|---|---|
| zeroed coefficients | BIC |
| 1 | 5.9442 |
| 2 | 6.0141 |
| 3 | 5.8658 |
| 4 | 2.5739 |
| 5 | 0.7070 |
| 6 | 8.5316 |
| 7 | 6.8247 |
| 8 | 6.4746 |
| 9 | 1.0095 |

The BIC becomes smallest when five coefficients are made zero. The Fourier coefficient at this time becomes
c*(f)=(3.3836, −1.5543−0.6156i, −0.5312−0.6937i. 0.3880+1.0122i, 0, 0, 0.4449+0.3820i, 0, 0, 0, 0, 0, 0, 0.4449−0.38201, 0, 0, 0,3880−1.0122i, −0.5312+0.6937i, −1.5543+0.61561).

When the total observation time of 72 hours is divided by 24, 3 is obtained, and in this case, since the number of coefficients is odd, the (3+1)th=4th Fourier coefficient is the efficient of a component corresponding to 24 hours. In the above Fourier coefficient c* in which the BIC is minimized, the fourth coefficient remains, and it is judged that the original signal in this case has the 24-hour period.

5.3 Example Judged not to Have Periodicity

5.3.1 Preparation of Data

Next, it is assumed that a following signal is desired to be judged.
X(t)=(−1.4654, −1.4850, −1.2409, −1.4725, −1.3649, −1.7453, −1.6136, −1.0707, −1.4604, −1.2874, −1.6219, −1.2768)

In this example, although all values are negative values, that does not influence the judgment. Similarly to the former example, the following obtained by the zero padding processing is made an original signal.
x(t)=(0, 0, 0, −1.4654, −1.4850, −1.2409, −1.4725, −1.3649, −1.7453, −1.6136, −1.0707, −1.4604, −1.2874, −1.6219, −1.2768, 0, 0, 0, 0)

Conditions other than the real number values, such as the number of dimensions and sampling time, are the same as the former example.

5.3.2 Discrete Fourier Transform

When the original signal is subjected to the discrete Fourier transform, the following Fourier coefficient is obtained.
c(f)=(−17.1048, 7.5483+2.7759i, 2.40006+1.6724i, −0.5611−0.1781i, −0.1600−3.0635i, −0.1939−0.3906i, −0.4484+0.6868i, −1.4494+1.3974i, 0.7866−0.2388i, 0.6297+0.2199i, 0.6297−0.2199i, 0.7866+0.2388i, −1.4494−1.3974i, −0.4484−0.6868i, −0.1939+0.3906i, −0.1600+3.0635i, −0.5611+0.1781i, 2.4006−1.6724i, 7.5483−2.7759i)

A 12-order real number vector in which the absolute values of the respective complex numbers are calculated is a following spectrum.
s(f)=(15.3987, 3.4043, 0.4505, 0.0182, 0.4953, 0.0100. 0.0354, 0.2133, 0.0356, 0.0234, 0.0234, 0.0356, 0.2133, 0.0354, 0.0100, 0.4953, 0.0182, 0.4505, 3.4043)

Coefficients of the spectrum are replaced by 0 one by one in ascending order of coefficient, and when the inverse Fourier transform to performed each time and the BIC is calculated, the value of the BIC is changed as follows.

| number of | |
|---|---|
| zeroed coefficients | BIC |
| 1 | 40.5022 |
| 2 | 39.9164 |
| 3 | 37.4113 |
| 4 | 36.3092 |
| 5 | 27.7080 |
| 6 | 34.6197 |
| 7 | 37.5438 |
| 8 | 34.4794 |
| 9 | 33.3881 |

The BIC becomes smallest when five coefficients are made zero similarly to the former example. The Fourier coefficient at this time is
c*(f)=(−17.1048, 7.5483+2.7759i, 2.4006+1.6724i, 0, −0.1600−3.0635i 0,0,1−1.4494+1.3974i, 0, 0, 0, 0, −1.4494−1.3974i, 0, 0, −0.1600+3.0635i, 0, 2.4006−1.67241, 7.5483−2.7759i).

Also in this case, the fourth Fourier coefficient is a coefficient of a component corresponding to 24 hours. In the above Fourier coefficient co in which the BIC is minimized, the fourth coefficient is replaced by 0. Accordingly, it is judged that the original signal does not have the 24-hour period.

<Explanation of Periodicity Judgment Apparatus>

Hereinafter, an embodiment of a periodicity judgment apparatus of the invention constructed based on the foregoing research content will be described with reference to the drawings. Besides, a periodicity judgment system including this apparatus, a periodicity judgment method using this apparatus, and a periodicity judgment program for executing this apparatus will also be described. Incidentally, in all drawings, similar components are denoted by similar reference numerals, and their explanation will be suitably omitted.

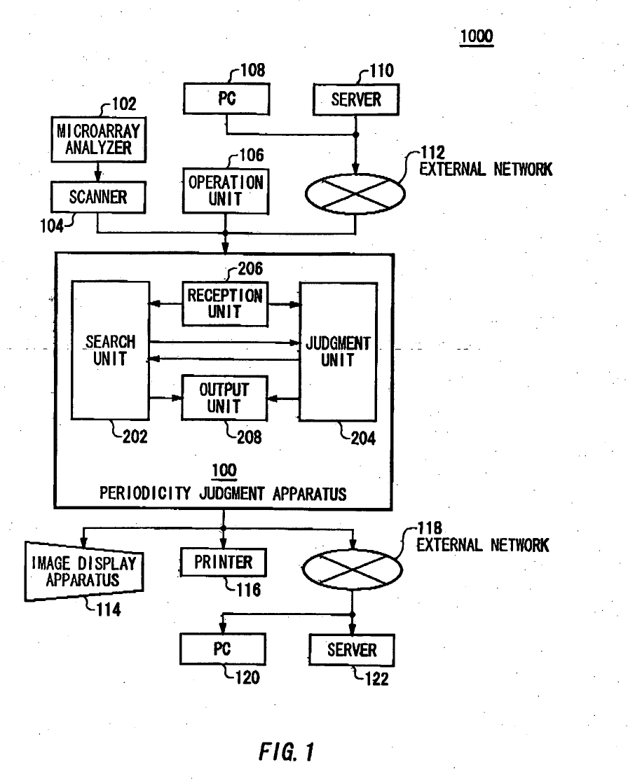

FIG. 1 is a functional block diagram showing the whole structure of the periodicity judgment system of the embodiment. The periodicity judgment system 1000 includes a periodicity judgment apparatus 100, and the periodicity judgment apparatus 100 judges the periodicity of time series data. Especially, the periodicity judgment apparatus 100 of this embodiment is used for a judgment method of the presence/absence of specific periodicity for time series data obtained by temporally analyzing gene expression data by microarray or as to what period a variation has.

The periodicity judgment apparatus 100 includes a reception part 206 to receive the time series data and a set value of a period from the outside. Besides, the periodicity judgment apparatus 100 includes a search unit 202 to search a Fourier coefficient vector in which an information criterion becomes smallest or minimum. Further, the periodicity judgment apparatus 100 includes a judgment unit 204 to judge whether the Fourier coefficient vector in which the information criterion becomes smallest or minimum includes a spectrum corresponding to a chosen period. The periodicity judgment apparatus 100 includes an output unit 208 to output a search result or a judgment result of the search unit 202 and the judgment unit 204.

Further, the periodicity judgment system 1000 includes an operation unit 106 to receive an operation to the periodicity judgment apparatus 100. Besides, the periodicity judgment system 1000 includes a microarray analyzer 102 for analyzing gene expression data of microarray and a scanner 104. Besides, the periodicity judgment system 1000 is connected to another PC (Personal Computer) 108 and a server 110 through an external network 112. The reception part 206 can acquire information from the operation unit 106, the scanner 104, the external network 112 and the like.

Besides, the periodicity judgment system 1000 includes an image display apparatus 114 to display, as an image, a search result or a judgment result outputted from the periodicity judgment apparatus 100. Besides, the periodicity judgment system 1000 includes a printer 116 to print the search result or the judgment result outputted from the periodicity judgment apparatus 100. Further, the periodicity judgment system 1000 includes another PC (Personal Computer) 120 and a server 122 to acquire the search result or the judgment result outputted from the periodicity judgment apparatus 100 through an external network 118. An output part 208 can output information to the image display apparatus 114, the printer 116, the external network 118 and the like.

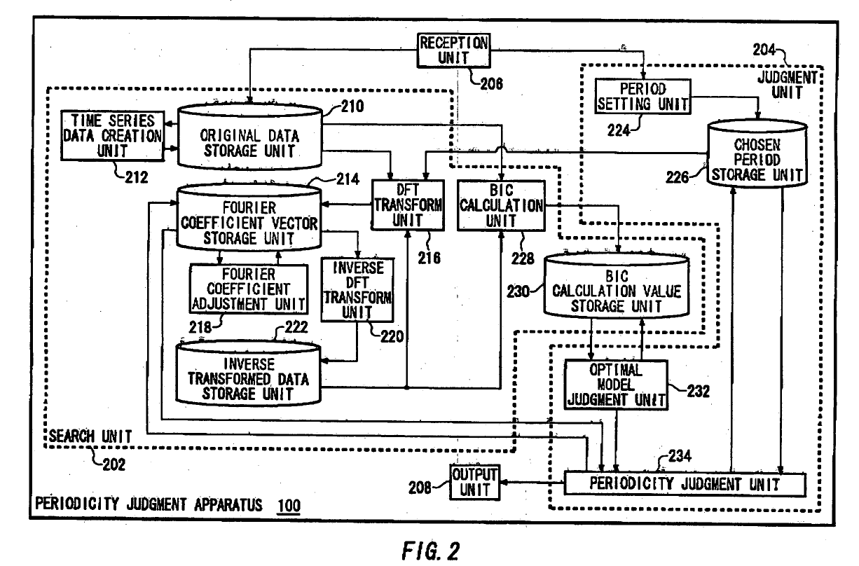

FIG. 2 is a functional block diagram showing the inner structure of the periodicity judgment apparatus included in the periodicity judgment system shown in FIG. 1. The periodicity judgment apparatus 100 includes the reception unit 206 (time series data reception unit) to receive the time series data. The reception unit 206 (period reception unit) receives also the set value of the period.

The search unit 202 of the periodicity judgment apparatus 100 includes an original data storage unit 210 to store original data acquired from the reception unit 206. The search unit 202 includes a time series data creation unit 212 to transform, in the case where the original data to be stored in the original data storage unit 210 is not in a form of time series data, the original data into the form of the time series data.

Besides, the search unit 202 includes a DFT transform unit 216 (Fourier transform unit) to perform Fourier transform of the time series data to obtain a Fourier coefficient vector. Further, the search unit 202 includes a Fourier coefficient vector storage unit 214 to store the Fourier coefficient vector acquired from the DFT transform unit 216.

Further, the search unit 202 includes a Fourier coefficient adjustment unit 218 (Fourier coefficient vector adjustment unit) to make an adjustment to simplify the Fourier coefficient vector corresponding to the time series data by deleting at least a part of Fourier coefficients included in the Fourier coefficient vector, and to obtain plural adjusted Fourier coefficient vectors different in adjustment level according to the degree of simplification.

Besides, the search unit 202 includes an inverse DFT transform unit 220 (inverse Fourier transform unit) to perform inverse Fourier transforms of the respective plural adjusted Fourier coefficient vectors and to obtain plural inverse transformed data. The search unit 202 includes an inverse transformed data storage unit 222 to store the plural inverse transformed data acquired from the inverse DFT transform unit 220.

Besides, the search unit 202 includes a BIC calculation unit 228 (information criterion calculation unit) to calculate an information criterion of each of the plural inverse transformed data. Further, the search unit 202 includes a BIC calculation value storage unit 230 to store plural BIC calculation values acquired from the BIC calculation unit 228. Incidentally, IDs and the BIC calculation values of the original data and the inverse transformed data are paired and are stored in the BIC calculation value storage unit 230. Thus, the IDs correspond to the respective Fourier coefficient vectors obtained by performing the Fourier transform of the original data and the inverse transformed data.

On the other hand, as described below, the judgment unit 204 of the periodicity judgment apparatus 100 includes a function to set a period to be judged and a function to judge, based on the search result of the search unit 202, whether the time series data of the original signal has the chosen period.

The judgment unit 204 includes a period setting unit 224, and the period setting unit 224 sets the period to be judged based on the information acquired from the reception unit 206. Besides, the judgment unit 204 includes a chosen period storage unit 226 to store the set value of the period acquired from the period setting unit 224.

Besides, the judgment unit 204 includes a periodicity judgment unit 234, and as described below, this periodicity judgment unit 234 judges whether a spectrum of the period of the set value is included in the Fourier coefficient vector corresponding to the inverse transformed data in which the BIC as the information criterion is smallest, and judges, by this, the presence/absence of the chosen period in the original signal.

In relation to the processing of the periodicity judgment unit 234, the judgment unit 204 includes an appropriate model judgment unit 232. The appropriate model judgment unit 232 judges an appropriate model based on the calculation value of the BIC acquired from the BIC calculation value storage unit 230. Here, plural BICs are stored in the BIC calculation value storage unit 230. The appropriate model judgment unit 232 obtains an adjusted Fourier coefficient vector corresponding to the inverse transformed data in which the BIC becomes smallest, and specifies the adjusted Fourier coefficient vector as the appropriate model.

The periodicity judgment unit 234 refers to the adjusted Fourier coefficient vector of the appropriate model obtained by the appropriate model judgment unit 232. The periodicity judgment unit 234 judges whether the peak of the chosen period is included in the adjusted Fourier coefficient vector. When the peak of the chosen period is included, the periodicity judgment unit 234 judges that the original signal has the chosen period. On the other hand, when the peak of the chosen period is not included, the periodicity judgment unit 234 judges that the original signal does not have the chosen period.

In this way, the periodicity judgment unit 234 judges whether the spectrum of the period of the set value is included in the Fourier coefficient vector corresponding to the inverse transformed data in which the information criterion such as the BIC is smallest, and judges, by this, the presence/absence of the chosen period in the original signal.

The judgment result of the periodicity judgment unit 234 is outputted from the output unit 208.

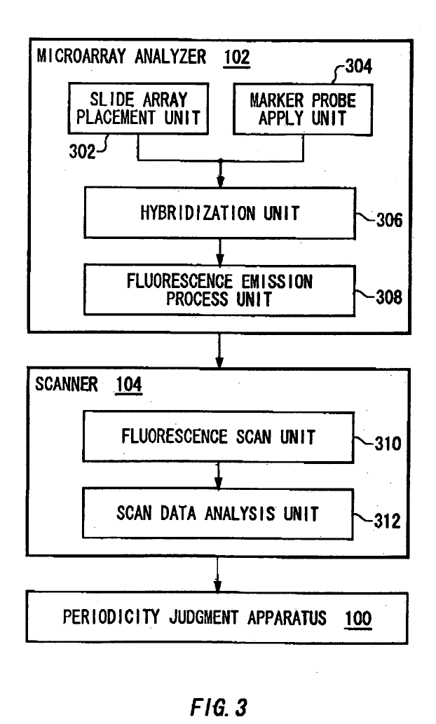

FIG. 3 is a functional block diagram showing the inner structures of the microarray analyzer and the scanner included in the periodicity judgment system shown in FIG. 1. The time series data as the original data to be processed by the foregoing periodicity judgment apparatus 100 is the time series data of gene expression level. Specifically, the time series data to be processed by the foregoing periodicity judgment apparatus 100 is the time series data obtained by detecting the respective cells of the microarray in the manner described below.

The microarray analyzer 102 includes a slide array placement unit 302 to place a slide array in which sample DNA is spotted. Besides, the microarray analyzer 102 includes a marker probe apply unit 304 to apply sample RNA, which is sampled from a biological specimen at specified time intervals and is probed with a marker, in the slide array.

Further, the microarray analyzer 102 includes a hybridization unit 306 to hybridize the sample DNA spotted in the slide array and the sample RNA probed with the marker and applied in the slide array. The microarray analyzer 102 includes a fluorescence emission process unit 308 to perform a fluorescence emission process of the RNA which has been hybridized and has been probed with the marker.

Besides, the scanner 104 includes a fluorescence scan unit 310 to perform the fluorescence scan of the slide array which has been subjected to the emission process by the fluorescence emission process unit 308. Further, the scanner 104 includes a scan data analysis unit 312 to analyze the fluorescence scan data acquired by the fluorescence scan unit 310 and to generate expression data of the sample RNA.

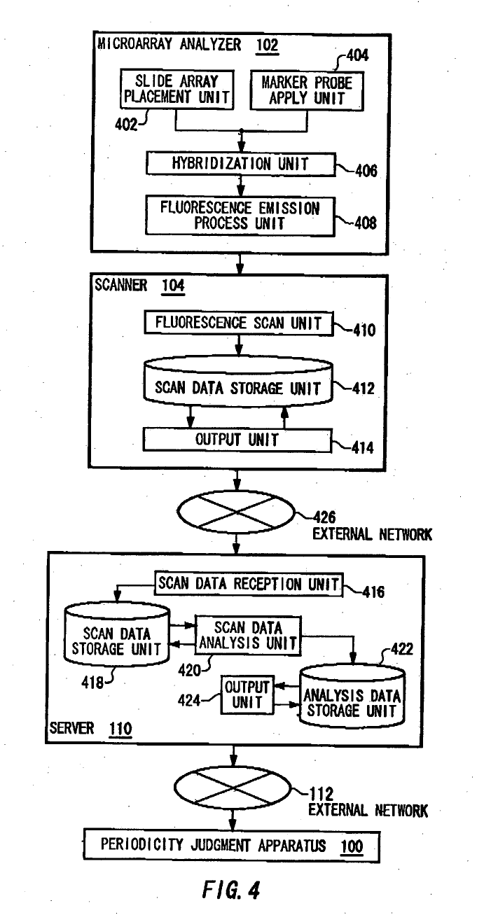

FIG. 4 is a functional block diagram showing the inner structures of a microarray analyzer, a scanner and a server included in a modified example of the periodicity judgment system of the embodiment. Similarly to the microarray analyzer 102 shown in FIG. 3, a microarray analyzer 102 of this modified example also includes a slide array placement unit 402, a marker probe apply unit 404, a hybridization unit 406, and a fluorescence emission process unit 408.

A scanner 104 of this modified example includes a fluorescence scan unit 410 to perform the fluorescence scan of a slide array which has been subjected to an emission process by the fluorescence emission process unit 408. The scanner 104 of this modified example further includes a scan data storage unit 412 to store fluorescence scan data acquired by the fluorescence scan unit 410. Further, the scanner 104 of this modified example includes an output unit 414 to output the fluorescence scan data acquired from the scan data storage unit 412 to a server 110 through an external network 426.

The server 110 of this modified example includes a scan data reception unit 416 to receive the fluorescence scan data from the scanner 104 through the external network 426. Besides, the server 110 of this modified example includes a scan data storage unit 418 to store the fluorescence scan data received by the scan data reception unit 416.

Further, the server 110 of this modified example includes a scan data analysis unit 420 to acquire and analyze the fluorescence scan data stored in the scan data storage unit 418 and to generate expression data of sample RNA. Besides, the server 110 of the modified example includes an analysis data storage unit 422 to store the expression data of the sample RNA generated by the scan data analysis unit 420. Besides, the server 110 of this modified example includes an output unit 424 to acquire the expression data of the sample RNA stored in the analysis data storage unit 422 and to output it to a periodicity judgment apparatus 100 through an external network 112.

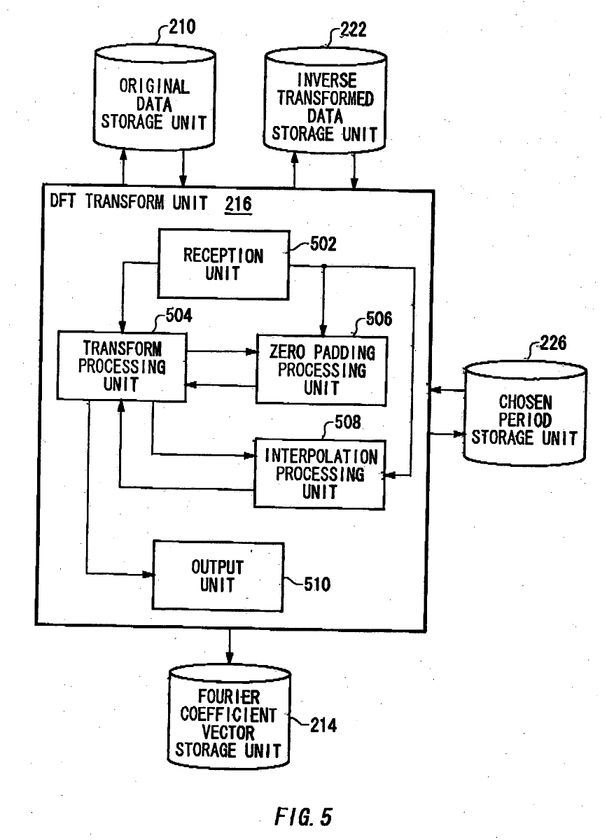

FIG. 5 is a functional block diagram showing the inner structure of the DFT transform unit included in the periodicity judgment apparatus shown in FIG. 2. The DFT transform unit 216 includes a reception unit 502 to acquire the original data, the inverse transformed data or the set value of the period from the original data storage unit 210, the inverse transformed data storage unit 222 or the chosen period storage unit 226. The reason why the reception unit 502 acquires the set value of the period is that an after-mentioned zero padding processing unit 506 uses the set value of the period. Besides, the DFT transform unit 216 includes a transform processing unit 504 to perform DFT transform (discrete Fourier transform) of the original data acquired by the reception unit 602.

Further, the DFT transform unit 216 includes a zero padding processing unit 506 which compares the original data acquired by the reception unit 502 with the set value of the period, and performs, in the case where the whole time width of the original data (time series data) is not a multiple of the set value of the period, the zero padding processing of the original data (time series data), so that the whole time width becomes a multiple of the set value of the period. In this case, the transform processing unit 504 performs the Fourier transform of the data which has been transformed by the zero padding processing unit 506.

Since this zero padding processing unit 506 is provided, sampling may not be performed at equal intervals. Even if not performed at equal intervals, data can be made equal interval data by the zero padding processing.

Besides, the DFT transform unit 216 includes an interpolation processing unit 508 which analyzes the original data acquired by the reception unit 502, and performs, in the case where the original data (time series data) is not equal interval data, an interpolation processing of the original data (time series data) to transform it into the equal interval data. In this case, the transform processing unit 504 performs the Fourier transform of the equal interval data which has been transformed by the interpolation processing unit 508.

Since this interpolation processing unit 508 is provided, the whole sampling time may not be integer times as large as an objective period. When there are plural sampling intervals, a value like the greatest common divisor of the intervals is made a new sampling time, and a value of a signal at the time point when there is no data is made 0. By doing so, the zero padding processing can be performed so that the whole sampling time becomes integer times as large as the objective period.

The original data (time series data) is transformed into a Fourier coefficient vector having plural peaks (spectrum) by the DFT transform unit 216. The DFT transform unit 216 includes an output unit 510 to output the transformed data (Fourier coefficient vector) subjected to the Fourier transform by the transform processing unit 504 to the Fourier coefficient vector storage unit 214.

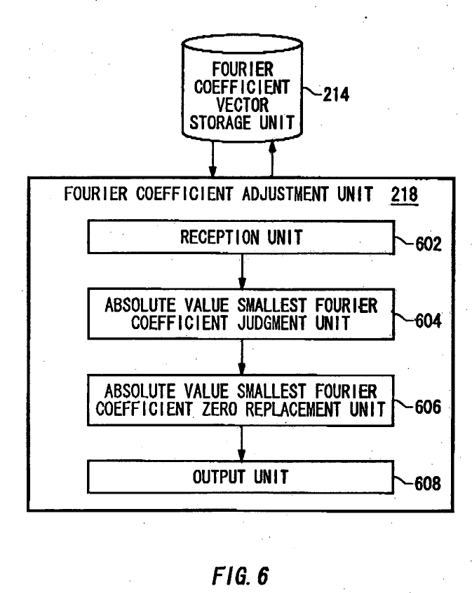

FIG. 6 is a functional block diagram showing the inner structure of the Fourier coefficient adjustment unit included in the periodicity judgment apparatus shown in FIG. 2. The Fourier coefficient adjustment unit 218 includes a reception unit 602 to acquire the Fourier coefficient vector from the Fourier coefficient vector storage unit 214.

Besides, the Fourier coefficient adjustment unit 218 includes an absolute value smallest Fourier coefficient judgment unit 604 to judge a Fourier coefficient having the smallest absolute value among Fourier coefficients of respective terms of a expression corresponding to the Fourier coefficient vector acquired by the reception unit 602. Further, the Fourier coefficient adjustment unit 218 includes an absolute value smallest Fourier coefficient zero replacement unit 606 to replace the Fourier coefficient, which is judged to be smallest by the absolute value smallest Fourier coefficient judgment unit 604, by 0. Besides, the Fourier coefficient adjustment unit 218 includes an output unit 608 to output the Fourier coefficient vector, which has been processed by the absolute value smallest Fourier coefficient zero replacement unit 606 and has already been subjected to the Fourier coefficient adjustment, to the Fourier coefficient vector storage unit 214.

In the another embodiment, in order to search the DFT vector having the minimum BIC score, the exhaust search of the combination of Fourier coefficients can be done, without deleting Fourier coefficient stepwise. That is, the exhaust search is done by calculating the value of the information criterion corresponding to the all combinations of the coefficients determined by the choice of the coefficients replaced to zero at each adjustment level from 0 to P. In this way, the accuracy of the search of the DFT vector having the minimum BIC score is improved.

The reception unit 602, the absolute value smallest Fourier coefficient judgment unit 604, the absolute value smallest Fourier coefficient zero replacement unit 606, and the output unit 608 process the Fourier coefficient vector in sequence, so that the Fourier coefficient having a small absolute value is replaced by 0, the number of peaks of the Fourier coefficient vector is decreased, and the Fourier coefficient vector is simplified as a model. In the Fourier coefficient adjustment unit 218, the processing of the absolute value smallest Fourier coefficient judgment unit 604 and the absolute value smallest Fourier coefficient zero replacement unit 606 is repeated plural times. By this, plural adjusted Fourier coefficient vectors different in adjustment level according to the degree of simplification are obtained.

As a result, by the function of the Fourier coefficient adjustment unit 218, in addition to the original Fourier coefficient vector obtained by performing the Fourier transform of the original data, the plural Fourier coefficient vectors different in adjustment level from the original Fourier coefficient vector are stored in the Fourier coefficient vector storage unit 214.

The adjustment level of the Fourier coefficient vector is an index to indicate the degree of simplification of the time series data corresponding to the Fourier coefficient vector. This adjustment level is indicated by the number of coefficients which are made zero in the coefficient vector. Alternatively, this adjustment level is indicated by the number of peaks of spectrum of the case where the Fourier coefficient vector is graphed.

When the processing of the Fourier coefficient adjustment unit 218 is seen from the viewpoint of change of Fourier coefficients of the above expression, the Fourier coefficient adjustment unit 218 (Fourier coefficient vector adjustment unit) functions as the above expression adjustment unit in which a term having a Fourier coefficient is deleted stepwise in ascending order of absolute value among Fourier coefficients of respective terms of the above expression corresponding to the Fourier coefficient vector acquired from the Fourier coefficient vector storage part 214, and plural above expressions different in the number of deleted terms are obtained.

When this processing is seen from the viewpoint of peak number change, the Fourier coefficient adjustment unit 218 (Fourier coefficient vector adjustment unit) has a function in which in ascending order of peak height corresponding to an absolute value of a Fourier coefficient included in the Fourier coefficient vector acquired from the Fourier coefficient vector storage unit 214, a Fourier coefficient corresponding to the peak is deleted stepwise, and plural adjusted Fourier coefficient vectors different in peak deletion number are generated as the plural adjusted Fourier coefficient vectors different in adjustment level.

Specifically, as described in the foregoing “Explanation of research content”, the Fourier coefficient adjustment unit 218 generates a vector in which some coefficients are replaced by 0 in a complex coefficient vector obtained by performing the discrete Fourier transform of the original signal and generates plural Fourier coefficient vectors as model data. In this case, when it is determined which coefficient is to be made zero, in case the number of coefficients is small and a calculation time is within a reasonable range, in addition to the combinations obtained by stepwise reduction of coefficients in ascending order of absolute value, all combinations may be tried.

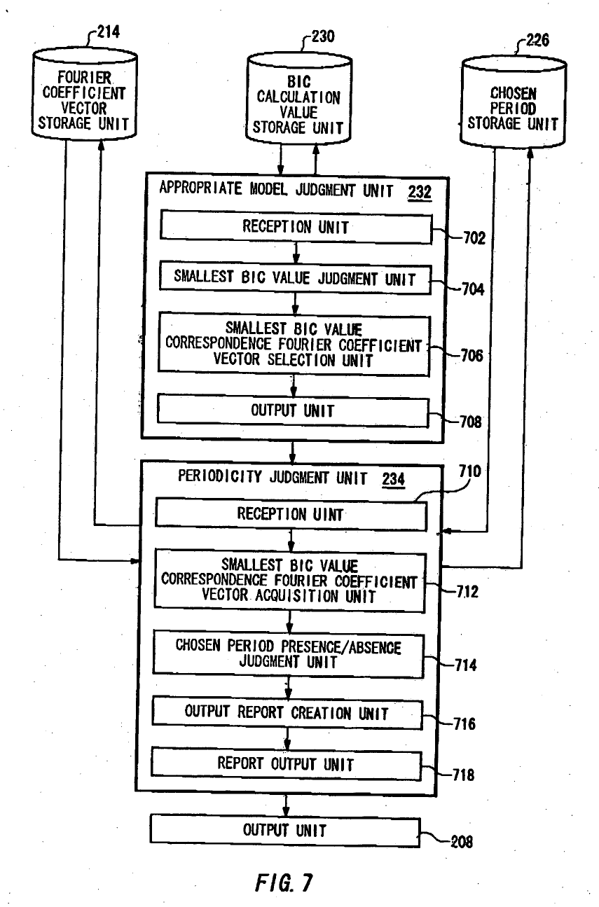

FIG. 7 is a functional block diagram showing the inner structures of the appropriate model judgment unit and the periodicity judgment unit included in the periodicity judgment apparatus shown in FIG. 2. The appropriate model judgment unit 232 includes a reception unit 702 to acquire the IDs and the BIC calculation values of the original data and the inverse transformed data from the BIC calculation value storage unit 230.

Besides, the appropriate model judgment unit 232 includes a smallest BIC value judgment unit 704 to judge the smallest or minimum BIC calculation value among the BIC calculation values acquired by the reception unit 702.

Further, the appropriate model judgment unit 232 includes a smallest BIC value correspondence Fourier coefficient vector selection unit 706 to select the ID of the original data or the inverse transformed data whose BIC calculation value is judged to be smallest or minimum by the smallest BIC value-judgment unit 704 (the ID corresponds to also the Fourier coefficient vector obtained by performing the Fourier transform of the original data or the inverse transformed data).

Besides, the appropriate model judgment unit 232 includes an output unit 708 to output the ID selected by the smallest BIC value correspondence Fourier coefficient vector selection unit 706 to the periodicity judgment unit 324.

The periodicity judgment unit 234 includes a reception unit 710 to acquire the ID selected by the smallest BIC value correspondence Fourier coefficient vector selection unit 706 from the appropriate model judgment unit 232, and to acquire the set value of the period from the chosen period storage unit 226.

Further, the periodicity judgment unit 234 includes a smallest BIC value correspondence Fourier coefficient vector acquisition unit 712 to acquire, from the Fourier coefficient vector acquisition unit 214, a Fourier coefficient vector corresponding to the ID of the original data or the inverse transformed data which is acquired by the reception part 710 and the BIC calculation value of which is judged to be smallest or minimum.

Besides, the periodicity judgment unit 234 includes a set frequency presence/absence judgment unit 714 to judge whether the spectrum of the period of the set value acquired by the reception part 710 is included in the Fourier coefficient vector acquired by the smallest BIC value correspondence Fourier coefficient vector acquisition unit 712 (the Fourier coefficient vector corresponding to the inverse transformed data whose information criterion is smallest or minimum).

Besides, the periodicity judgment unit 234 includes an output report creation unit 716 to create an output report to indicate the judgment result of the chosen period presence/absence judgment unit 714.

In the case where the Fourier coefficient corresponding to the spectrum of the period of the set value is included in the Fourier coefficient vector corresponding to the inverse transformed data whose information criterion is smallest or minimum, the output report creation unit 716 creates a report that the period of the set value exists. On the other hand, in the case where the Fourier coefficient corresponding to the spectrum of the period of the set value is not included in the Fourier coefficient vector corresponding to the inverse transformed data whose information criterion is smallest or minimum, the output report creation unit 716 creates a report that the period of the set value does not exist.

Further, the periodicity judgment unit 234 includes a report output unit 718 to output the report created by the output report creation unit 716 to the output unit 208.

Specifically, as described in the foregoing “Explanation of research content”, the BIC calculation unit 228 calculates information criteria (BIC) concerning plural model data (Fourier coefficient vectors) different in adjustment level, and stores the plural obtained BIC calculation values into the BIC calculation value storage unit 230.

The appropriate model judgment unit 232 acquires the plural BIC calculation values from the BIC calculation value storage unit 230, and selects the ID of the Fourier coefficient vector in which the BIC calculation value is smallest or minimum. The appropriate model judgment unit 232 delivers this ID to the periodicity judgment unit 234.

The periodicity judgment unit 234 judges whether the original signal has the periodicity based on whether or not the coefficient corresponding to the noted period (chosen period) is included in the Fourier coefficient vector which corresponds to the ID acquired from the appropriate model judgment unit 232 and in which the BIC calculation value is smallest or minimum.

Hereinafter, the operation of the periodicity judgment apparatus of the embodiment will be described.

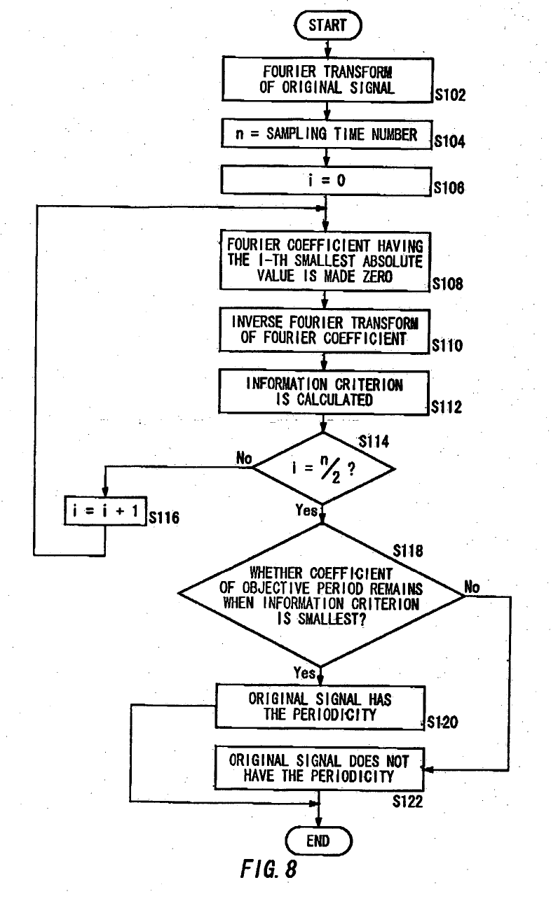

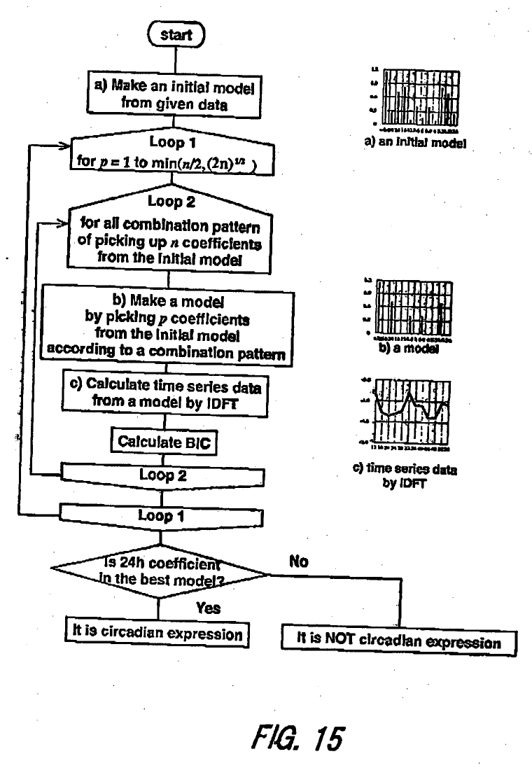

FIG. 8 is a flowchart for explaining the operation of the periodicity judgment apparatus of the embodiment. The periodicity judgment apparatus 100 starts a series of operations when the reception unit 206 receives the original data and the set value of the period. FIG. 15 is a more detailed flowchart for explaining one example of the operation of the periodicity judgment apparatus of the embodiment.

First, the reception unit 206 delivers the received original data to the original data storage unit 210. Besides, the reception unit 206 delivers the received set value of the period to the period set unit 224. The original data storage unit 210 having acquired the original data stores the original data. At this time, in the case of n=sampling time number, the numeral n is paired with the original data and is stored in the original data storage unit 210.

On the other hand, the periodicity judgment unit 224 having acquired the set value of the period stores the set value of the period into the chosen period storage unit 226. At this time, in the case where it is necessary to convert the unit of the set value of the period, the period set unit 224 converts the numeral and the unit of the acquired set value, pairs the set value with the unit, and stores them into the chosen period storage unit 226.

Next, the time series data creation unit 212 acquires the original data stored in the original data storage unit 210, and transforms, in the case where the original data is not the time series data, the original data into the time series data, and stores it into the original data storage unit 210. Also at this time, in the case of n=sampling time number, the numeral n is paired with the transformed time series data, and is stored in the original data storage unit 210.

Subsequently, the DFT transform unit 216 acquires the original data (original signal) from the original data storage unit 210, and performs the discrete Fourier transform (S102). The DFT transform unit 216 stores the Fourier coefficient vector obtained by performing the discrete Fourier transform of the original data (original signal) into the Fourier coefficient vector storage unit 214. At this time, in the case of n=sampling time number, the numeral n is paired with the Fourier coefficient vector and is stored in the Fourier coefficient vector storage unit 214 (S104).

The DTF transform unit 216 acquires the set value of the period from the chosen period storage unit 226, and in the case where the whole time width of the original data is not a multiple of the set value of the period, the DTF transform unit performs the zero padding processing of the original data to transform it so that the whole time width becomes a multiple of the set value of the period, and performs the discrete Fourier transform. In the case where the original data is not equal interval data, the DTF transform unit 216 performs the interpolation processing of the original data to transform it into the equal interval data, and performs the discrete Fourier transform of the equal interval data.

Next, the DTF transform unit 216 sets the Fourier coefficient adjustment count to i=0, pairs the numeral i=0 with the Fourier coefficient vector being processed at present and the corresponding original data (original signal), and stores them into the Fourier coefficient vector storage unit 214 (S106). The Fourier coefficient adjustment unit 218 acquires the Fourier coefficient vector corresponding to i=0 from the Fourier coefficient vector storage unit 214, replaces the Fourier coefficient having the ith smallest absolute value by 0, and generates the Fourier coefficient vector corresponding to i=1 (S108). At this time, since the spectral data corresponding to the Fourier coefficient vector is symmetrical, two Fourier coefficients having the same magnitude disappear at the same time. The Fourier coefficient adjustment unit 218 pairs the replaced Fourier coefficient vector with i=1, and stores them into the Fourier coefficient vector storage unit 214.

Further, the inverse OFT transform unit 220 acquires the Fourier coefficient vector corresponding to i=1 from the Fourier coefficient vector storage unit 214, and performs the inverse Fourier transform of the Fourier coefficient vector to obtain the inverse transformed data corresponding to i=1 (S110). The inverse DFT transform unit 220 pairs the inverse transformed data with i=1 and stores them into the inverse transformed data storage unit 222.

Subsequently, the BIC calculation unit 228 acquires the inverse transformed data corresponding to i=1 from the inverse transformed data storage unit 222, and calculates the BIC (information criterion) of the inverse transformed data (S112). The BIC calculation unit 228 pairs the BIC (information criterion) with i=1 and stores them into the BIC calculation value storage unit 230.

Next, the DFT transform unit 216 judges whether i is n/2 with respect to the Fourier coefficient adjustment count i=0 set at the last time (S114). At this time, since n is the sampling time number (for example, 24), it is judged that the relation has not been established (No), i is made i+1 (that is, the Fourier coefficient adjustment count i=1), and advance is made to a next cycle (S116).

That is, the Fourier coefficient adjustment count i is made i=1, and the Fourier coefficient adjustment unit 218 acquires the Fourier coefficient vector corresponding to i=1 from the Fourier coefficient vector storage unit 214, replaces the Fourier coefficient having the ith smallest absolute value by 0, and generates the Fourier coefficient vector corresponding to i=2 (S108). Further, similarly to the foregoing, step 110, step 112, step 114 and step 116 are repeated. When this cycle is repeated 12 times, i=n/2 is established (Yes) at step 114, and advance is made to step 118.

In the another embodiment, in order to search the DFT vector having the minimum BIC score, the exhaust search of the combination of Fourier coefficients can be done, without deleting Fourier coefficient stepwise. That is, the exhaust search is done by calculating the value of the information criterion corresponding to the all combinations of the coefficients determined by the choice of the coefficients replaced to zero at each adjustment level from 0 to P. In this way, the accuracy of the search of the DFT vector having the minimum BIC score is improved.

The reason why it is judged at step 114 whether i=n/2 is established is that the spectral data corresponding to the Fourier coefficient vector subjected to the Fourier transform is symmetrical, and two Fourier coefficients simultaneously become 0 by the processing of step 108.

In this way, step 110, step 112, step 114, and step 116 are repeated, so that plural adjusted Fourier coefficient vectors are obtained in which the small Fourier coefficients are subsequently deleted. That is, the plural adjusted Fourier coefficient vectors different in adjustment level according to the degree of simplification can be obtained. As described in the foregoing “Explanation of research”, this processing corresponds to obtaining plural different complex coefficient vectors in which some coefficients are replaced by 0 from the complex coefficient vector obtained by performing the discrete Fourier transform of the time series data as the original signal. Besides, by the foregoing series of processing, plural BIC calculation values respectively corresponding to the adjusted Fourier coefficient vectors are obtained.

At step 118, the appropriate model judgment unit 232 acquires the BIC calculation value stored in the BIC calculation value storage unit 230, and judges the minimum BIC calculation value and the corresponding ID. Next, the periodicity judgment unit 234 acquires the minimum BIC calculation value and the corresponding ID from the appropriate model judgment unit 232, and acquires the set value of the period from the chosen period storage unit 226. Besides, the periodicity judgment unit 234 acquires the Fourier coefficient vector corresponding to the inverse transformed data having the smallest BIC calculation value from the Fourier coefficient vector storage unit 214 based on the ID corresponding to the smallest BIC calculation value.

Subsequently, the periodicity judgment unit 234 compares the adjusted Fourier coefficient vector corresponding to the inverse transformed data having the minimum BIC calculation value with the period of the set value, and judges whether the Fourier coefficient corresponding to the spectrum of the period of the set value is included in the adjusted Fourier coefficient vector. That is, the periodicity judgment unit 234 judges whether the coefficient of the objective period remains when the information criterion is smallest (S118).

When judging that the coefficient of the objective period remains when the information criterion is smallest (Yes), the periodicity judgment unit 234 outputs, through the output unit, 208, a judgment result that the original signal has the period (S120). On the other hand, when judging that the coefficient of the objective period does not remain when the information criterion is smallest (No), the periodicity judgment unit 234 outputs, through the output unit 208, a judgment result that the original signal does not have the periodicity (S122).

When the foregoing series of steps are completed, the periodicity judgment apparatus 100 ends the operation.

Hereinafter, the data structure of data to be processed by the periodicity judgment apparatus of the embodiment and the image display of the data will be described.

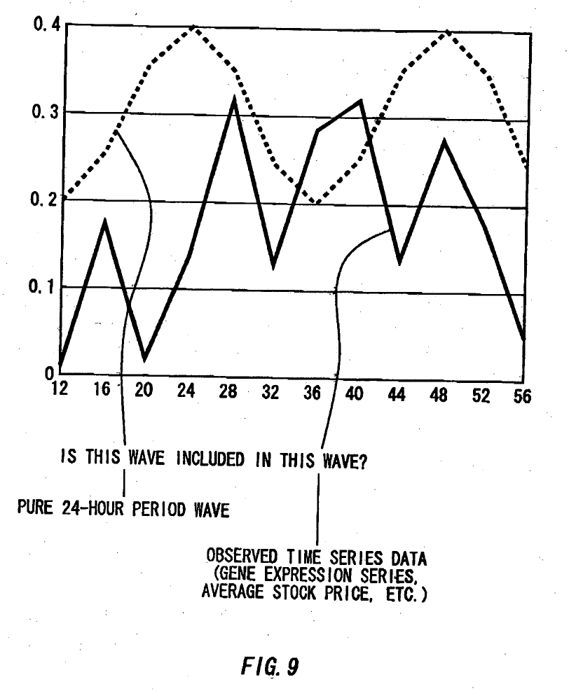

FIG. 9 is a graph for explaining the concept of a periodicity judgment method of an embodiment. The horizontal axis of FIG. 9 indicates the time of sampling. On the other hand, the vertical axis of FIG. 9 indicates the gene expression intensity. The periodicity judgment apparatus 100 is used for judging whether for example, a wave of a pure 24-hour period indicated by an upper dotted line of the graph of FIG. 9 is included in observed time series data (time series data of gene expression series) indicated by a lower solid line of the graph of FIG. 9.

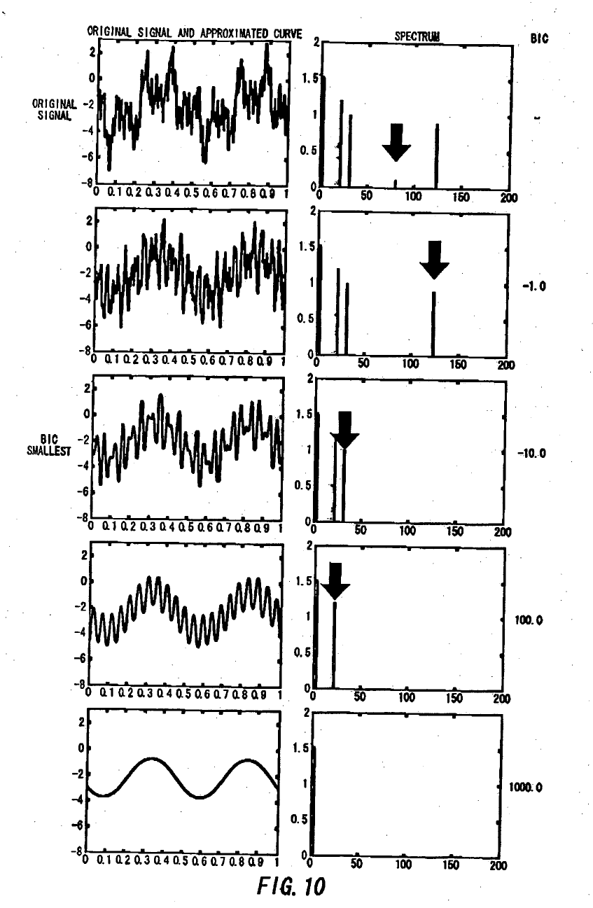

FIG. 10 is a view for explaining the periodicity judgment method of the embodiment. The left column of FIG. 10 indicates graphs of time series data of an original signal and approximated curves (inverse transformed data of simplified models), the horizontal axis indicates the sampling time of the time series data, and the vertical axis indicates the intensity of the time series data. The right column of FIG. 10 indicates graphs of spectral data corresponding to the Fourier coefficient vectors of the time series data, the horizontal axis indicates the frequency of the spectrum, and the vertical axis indicates the absolute value of the peak of the spectrum. Incidentally, although the graph of the spectral data corresponding to the Fourier coefficient vector is symmetrical with respect to the y axis, FIG. 10 shows only the right half. Besides, the corresponding BIC calculation values are indicated at the right end of FIG. 10.

In FIG. 10, the uppermost stage of the left column indicates the time series data of the original signal. This data is subjected to the Fourier transform, and spectral data corresponding to a Fourier coefficient vector and shown at the uppermost right is obtained. Then, the smallest peak indicated by an arrow is deleted, and spectral data corresponding to a modeled Fourier coefficient vector and shown at the second stage is obtained. The left time series data is obtained by performing the inverse Fourier transform of the Fourier coefficient vector corresponding to the model of this spectral data, and further, the BIC calculation value at the right end is calculated from this time series data.

Similarly, a smallest peak indicated by an arrow is sequentially deleted, and the model of the spectral data corresponding to the Fourier coefficient vector is simplified. The inverse transformed data of the left column is obtained from the Fourier coefficient vector corresponding to each model, and the BIC calculation value is calculated from the inverse transformed data.

From FIG. 10, a state is seen in which the peak of the spectrum is sequentially deleted (adjusted) in ascending order of peak height in the spectral data corresponding to the Fourier coefficient vector. When the corresponding BIC calculation value is seen, it is understood that when the adjustment (delete) number of the spectrum is two (third stage from the top), the BIC calculation value becomes −10.0 and becomes smallest. The Fourier coefficient vector corresponding to the spectral data at the third stage is used in the periodicity judgment.

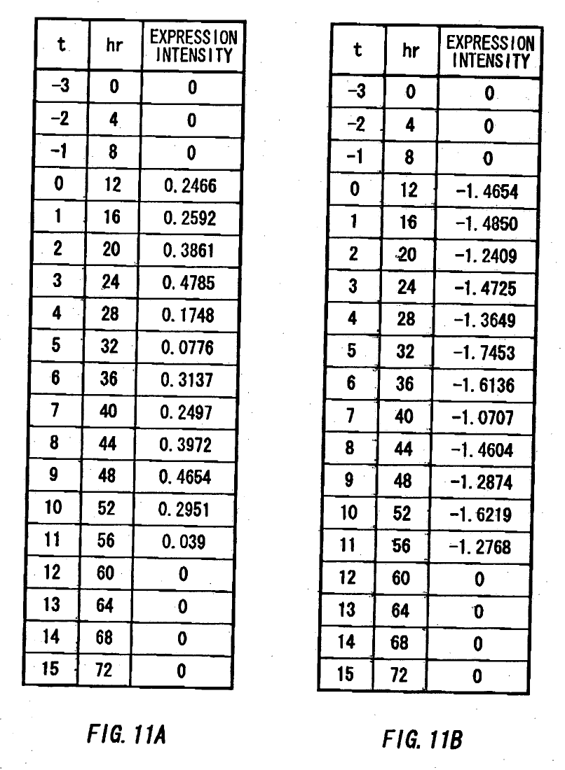

FIGS. 11A and 11B are data structural views for explaining the structure of the time series data which the periodicity judgment apparatus of this embodiment receives. The reception unit 206 of the periodicity judgment apparatus 100 can receive the time series data having such a table structure.

FIG. 11A is a table of time series data corresponding to “Example judged to have periodicity” described in the foregoing item of “Explanation of research content”. FIG. 11B is a table of time series data corresponding to “Example judged not to have periodicity” described in the foregoing item of “Explanation of research content”.

Hereinafter, the operation and effect of the periodicity judgment apparatus of the embodiment will be described.

According to the periodicity judgment apparatus 100 of the embodiment, since the BICs of the inverse transformed data obtained by performing the inverse Fourier transforms of plural Fourier coefficient vectors different in adjustment level according to the degree of simplification are calculated, the Fourier coefficient vector in which the BIC becomes smallest or minimum can be obtained by calculation. Thus, a trial and error, and an empirical judgment for determining a judgment criterion can be reduced. As a result, the mixing of a subjective or arbitrary judgment criterion is suppressed, and the periodicity of the time series data can be objectively judged.

According to the periodicity judgment apparatus 100 of the embodiment, the Fourier coefficient adjustment unit 218 includes the absolute value smallest Fourier coefficient zero replacement unit 606 which deletes the peak stepwise in ascending order of peak height in the spectral data corresponding to the Fourier coefficient vector, and generates, as plural adjusted Fourier coefficient vectors different in adjustment level, the adjusted Fourier coefficient vectors corresponding to the plural spectral data different in the number of deleted peaks. Thus, the trial and error, and the empirical judgment to determine the judgment criterion can be reduced. As a result, the mixing of the subjective or arbitrary judgment criterion is suppressed, and the periodicity of the time series data can be objectively judged.

Besides, according to the periodicity judgment apparatus 100 of the embodiment, the Fourier coefficient adjustment unit 218 includes the absolute value smallest Fourier coefficient zero replacement unit 606 which deletes a term including a Fourier coefficient stepwise in ascending order of absolute value among Fourier coefficients included in a Fourier coefficient vector, and obtains plural expressions different in the number of deleted terms. Thus, the trial and error, and the empirical judgment for determining the judgment criterion can be reduced. As a result, the mixing of the subjective or arbitrary judgment criterion is suppressed, and the periodicity of the time series data can be objectively judged.

Besides, according to the periodicity judgment apparatus 100 of the embodiment, the DFT transform unit 216 includes the interpolation processing unit 508 which, in the case where the time series data is not equal interval data, performs the interpolation processing of the time series data to transform it into the equal interval data, and performs the Fourier transform of the equal interval data. Thus, even if the time series data is not the equal interval data, the DFT transform unit 216 can perform the discrete Fourier transform. As a result, the periodicity judgment apparatus 100 can extend the application range of time interval of the time series data whose periodicity can be judged.

Besides, according to the periodicity judgment apparatus 100 of the embodiment, the DFT transform unit 216 includes the zero padding processing unit 506 which, in the case where the whole time width of the time series data is not a multiple of the set value of the period, performs the zero padding processing of the time series data to make a transformation so that the whole time width becomes a multiple of the set value of the period. Thus, even if the whole time width of the time series data is not a multiple of the set value of the period, the DFT transform unit 216 can perform the discrete Fourier transform. As a result, the periodicity judgment apparatus 100 can extend the application range of the whole time width of the time series data whose periodicity can be judged.

Besides, the periodicity judgment apparatus 100 of the embodiment is suitable for the judgment of periodicity of time series data observed in the life phenomenon, social phenomenon or the like. The periodicity judgment apparatus 100 is suitable especially for the judgment of periodicity of time series data of gene expression data among the life phenomenon, social phenomenon and the like. The periodicity judgment apparatus 100 is suitable especially for the judgment of periodicity of time series data of data obtained by detecting the respective cells of microarray among the time series data of the gene expression data.

Hereinafter, the operation and effect of the periodicity judgment apparatus 100 will be described in more detail with reference to the drawings.

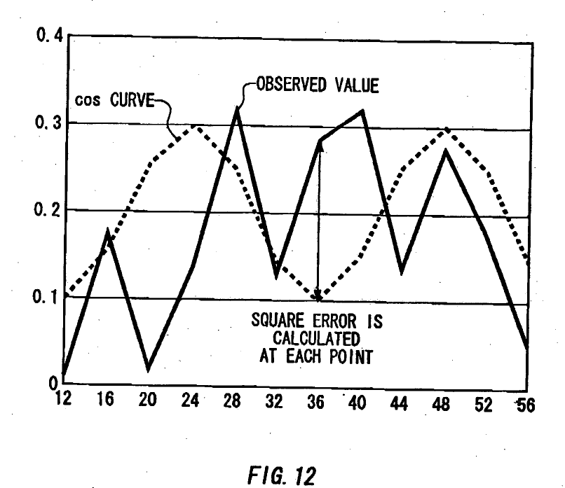

FIG. 12 is a graph for explaining the concept of a cosinor method. The horizontal axis of FIG. 12 indicates the time of sampling. On the other hand, the vertical axis of FIG. 12 indicates the time series data such as gene expression intensity.

In the cosinor method, the best approximated trigonometric function is judged with reference to a period, amplitude, an apex phase and the like. For example, a cos curve indicated by a dotted line of the graph of FIG. 12 is applied to observed time series data (time series data of gene expression series) indicated by a solid line of the graph of FIG. 12 by the least square method or the like, and when an approximation error is small, the model is adopted, and it is judged that the periodicity of the model exists also in the original signal.

As stated above, since it is judged that the data also has the period in the case where the approximation error is sufficiently small, it is necessary that a square error as a threshold value and the like are empirically determined. That is, it is necessary to previously determine an acceptable level of approximation at which the model is adopted (judgment of having the period is made). As a practical problem, the optimization often can not be performed unless the cos curve is estimated to some degree. Thus, a trial and error, and an empirical judgment become necessary, and the periodicity judgment result is liable to become arbitrary and subjective.

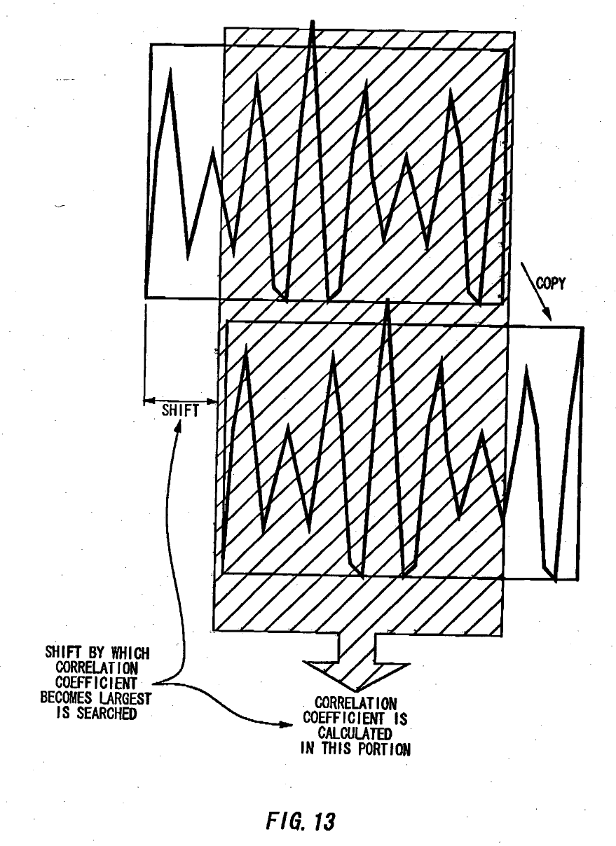

FIG. 13 is a graph for explaining the concept of autocorrelation analysis. The horizontal axis of FIG. 13 indicates the time of sampling. On the other hand, the vertical axis of FIG. 13 indicates the time series data such as gene expression intensity.

In the autocorrelation analysis, a correlation coefficient between an original signal and a signal obtained by shifting only the time of the original signal is calculated, and when the correlation coefficient is large, it is judged that the shift is the period of the original signal. For example, observed time series data (time series data of gene expression series) indicated by a solid line of the graph of FIG. 13 is shifted by a shift width, is copied, and is overlapped with itself, and the correlation coefficient is calculated in an oblique line portion (overlap portion). While the shift width is gradually changed, the shift width by which the correlation coefficient becomes largest is searched. As a result, when the maximum value of the correlation coefficient is sufficiently large, the judgment of having the period is made.

Also in the autocorrelation analysis, it is necessary to previously determine an acceptable level of a magnitude of the correlation coefficient at which the judgment of having the period is made, or an acceptable level of a value at the time when the correlation coefficient becomes largest. Thus, a trial and error, and an empirical judgment become necessary, and the periodicity judgment result is liable to become arbitrary and subjective.

Differently from the cosinor method and the autocorrelation method as stated above, the periodicity judgment apparatus 100 of the embodiment realizes objective analysis by calculating the information criterion value.

Next, a description will be given to a difference between the conventional periodicity analysis by Fourier transform (hereinafter simply referred to as the conventional Fourier analysis) and the periodicity analysis of this embodiment. In this embodiment, a simple Fourier analysis is not-used, but the judgment using the information criterion is combined with the Fourier transform. By this, as described below, the periodicity analysis which can not be performed by the conventional Fourier analysis is enabled, and in more detail, the periodicity judgment of time series data (for example, gene expression data) of a kind in which the conventional Fourier analysis can not be applied is enabled.

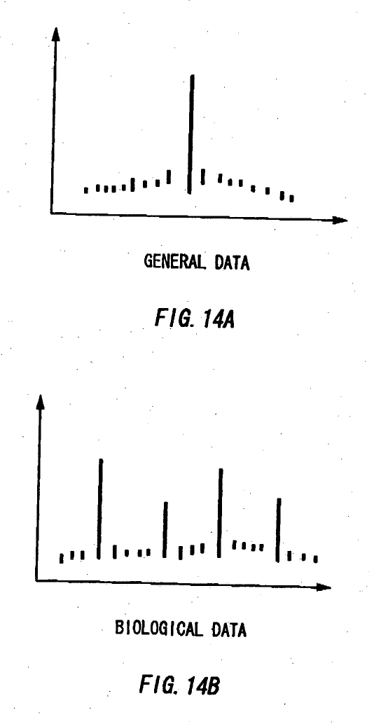

FIG. 14A is a schematic view of spectral data corresponding to a Fourier coefficient vector suitable for the conventional Fourier analysis. In FIG. 14A, a single large peak appears. In the conventional method, it is judged whether this large peak coincides with an objective period. The analysis object of the conventional method is time series data in which it is previously known that a single large peak appears by the Fourier transform as shown in FIG. 14A. In other words, the analysis object is limited to the data in which a single large peak appears.

On the other hand, FIG. 14B is a schematic view of spectral data corresponding to a Fourier coefficient vector obtained by performing the Fourier transform of time series data of gene expression level used in this embodiment. As shown in FIG. 14B, when the data of the gene expression level is subjected to the Fourier transform, plural large peaks appear. Further, the largest peak does not necessarily correspond to the objective period. The second, third or smaller peak may correspond to the objective period. Accordingly, the conventional Fourier analysis to judge the presence/absence of a single large peak can not be used for the data of the gene expression level as shown in FIG. 14B.

It is conceivable that conventional Fourier analysts is applied and a judgment is made as to whether the peak of an objective period is included before specified order. However, at the time point when the specified order is set, that as, in the judgment as to how many peaks are considered, the arbitrary and subjective judgment is mixed, and it becomes hard to obtain an objective judgment result.

On the other hand, in this embodiment, as described above, a small peak is sequentially deleted from the spectral data corresponding to the Fourier coefficient vector, and the information criterion is calculated based on the Fourier coefficient vector at each delete time point (specifically, the BIC or the like is calculated from the inverse transformed data of the Fourier coefficient vector). The spectral data corresponding to the Fourier coefficient vector in which the information criterion is smallest is made the appropriate model, and when the objective period remains in the appropriate model, it is judged that the target time series data includes the objective period. Since the processing as stated above is performed, the periodicity of data as shown in FIG. 14B can also be appropriately judged. That is, even if the magnitude of the peak corresponding to the objective period is the second or less, the judgment of periodicity can be made. Further, since the information criterion as the objective information amount is processed, it is possible to avoid that the periodicity judgment result becomes arbitrary or subjective.

Actually, as test implementation, with respect to time series data of 12422 genes×12 points, the periodicity judgment by the periodicity judgment apparatus of the embodiment was made by using MAC OS X, MATLAB, and a judgment result with high reliability could be obtained in about two minutes.

Although the embodiments of the invention have been described with reference to the drawings, these are examples of the invention, and various structures other than the above can also be adopted.

For example, in the embodiment, although the information criterion is made the BIC (Baysian Information Criterion), AIC (Akaike's information criterion) may be used. Besides, in addition to the BIC and the AIC, what is calculated from a difference between a model and a signal, and the number of parameters of the model can be used as the information criterion.

Also in the case where the Fourier transform is used, since something scattering around a true value ought to have been observed, it is necessary to previously set a distribution function. In this case, when the normal distribution is assumed, it is sufficient if only variance is considered (residual variance of a difference between data and model). Thus, in the case where the distribution function is unknown, when the normal distribution is assumed, the information criterion can be calculated.

As the Fourier transform, not only the DFT (Discrete Fourier Transform), but also FFT (Fast Fourier Transform) can be performed when data satisfies a necessary condition. Also in this case, since a Fourier coefficient vector having plural peaks can be obtained, the operation and effect similar to the above can be obtained.

Besides, in the embodiment, although the biological data has been described, also with respect to the social data such as stock price index, when it is used as the original data, the periodicity can be objectively judged. This is because a Fourier coefficient vector having plural large peaks is often obtained when the social data such as the stock price index is subjected to the Fourier transform.

For example, as a mode of the invention, the periodicity judgment program can be installed as software on a calculator. Both hardware and software may be those commercially available. For example, as the hardware, a super computer, a PC, or a server can be used. As the software, Windows XP, MAC OS X, MATLAB or the like can be used.

Besides, in the above embodiment, the method is used in which the Fourier coefficient is decreased one by one in order to obtain a sufficiently appropriate model. However, the invention is not particularly limited, and the best model can also be searched by exhaustive search or approximation search. At this time, in the exhaustive search, with respect to which Fourier coefficient included in the Fourier coefficient vector is made 0, the information criterion is calculated for all possible combinations and the best model is determined.

On the other hand, the approximation search generally indicates a method in which when the number of time points of the time series data is large and the exhaustive search is actually difficult because of a sharp increase of combinations or the like, a model which is not best but is close to the best is searched. The approximation search includes a genetic algorithm, a simulated annealing and the like.

As described above, the periodicity judgment apparatus of the invention has the effect that the periodicity of the time series data can be objectively judged, and the invention is useful as the periodicity judgment apparatus, the periodicity judgment method, the periodicity judgment program or the like.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

What is claimed is:

1. A periodicity judgment apparatus for judging periodicity of time series data, comprising:
a time series data reception unit to receive the time series data;
a period reception unit to receive a set value of a period;
a Fourier transform unit to perform a Fourier transform of the time series data to obtain a Fourier coefficient vector;
a Fourier coefficient vector adjustment unit to perform a simplification adjustment on the Fourier coefficient vector corresponding to the time series data by removing at least a part of Fourier coefficients included in the Fourier coefficient vector and to obtain plural adjusted Fourier coefficient vectors different in adjustment level according to degree of simplification;
an inverse Fourier transform unit to perform inverse Fourier transforms of the respective plural adjusted Fourier coefficient vectors to obtain plural inverse transformed date;
an information criterion calculation unit to calculate an information criterion of each of the plural inverse transformed data;
a periodicity judgment unit to judge whether a spectrum of the period of the set value is included in the Fourier coefficient vector corresponding to the inverse transformed data whose information criterion is smallest or minimum; and
an output unit to output a judgment result of the periodicity judgment unit.

2. The periodicity judgment apparatus according to claim 1, wherein the Fourier coefficient vector adjustment unit performs the simplification adjustment on the Fourier coefficient vector corresponding to the time series data by preferentially deleting the Fourier coefficient having a small absolute value, and obtains the plural adjusted Fourier coefficient vectors different in the adjustment level according to the degree of simplification.

3. The periodicity judgment apparatus according to claim 1, wherein the Fourier coefficient vector adjustment unit uses, as combinations of the Fourier coefficients to be deleted from the Fourier coefficient vector, all combinations which can be constructed by the Fourier coefficients included in the Fourier coefficient vector.

4. The periodicity judgment apparatus according to claim 1, wherein the Fourier coefficient vector adjustment unit includes a Fourier coefficient delete unit to delete at least a part of the Fourier coefficients included in the Fourier coefficient vector, and generates plural adjusted Fourier coefficient vectors different in the number of deleted Fourier coefficients as the plural Fourier coefficient vectors different in the adjustment level.

5. The periodicity judgment apparatus according to claim 1, wherein the Fourier coefficient vector adjustment unit generates, as the plural Fourier coefficient vectors different in the adjustment level, plural adjusted Fourier coefficient vectors different in combination of the Fourier coefficients deleted from the Fourier coefficient vector corresponding to the time series data.

6. The periodicity judgment apparatus according to claim 1, wherein in a case where the time series data is not equal interval data, the Fourier transform unit performs an interpolation processing of the time series data to transport it into equal interval data, and performs a Fourier transform of the equal interval data.

7. The periodicity judgment apparatus according to claim 1, wherein in a case where a whole time width of the time series data is not a multiple of the set value of the period, the Fourier transform unit performs a zero padding processing of the time series data to make the whole time width a multiple of the set value of the period, and performs a Fourier transform of the transformed data.

8. The periodicity judgment apparatus according to claim 1, wherein the time series data is time series data of gene expression level.

9. The periodicity judgment apparatus according to claim 1, wherein the time series data is obtained by detecting respective cells of microarray.

10. A periodicity judgment method for judging periodicity of time series data, comprising the steps of:
performing a Fourier transform of the time series data to obtain a Fourier coefficient vector;
performing a simplification adjustment on the Fourier coefficient vector corresponding to the time series data by removing at least a part of Fourier coefficients included in the Fourier coefficient vector to obtain plural adjusted Fourier coefficient vectors different in adjustment level according to degree of simplification;
performing inverse Fourier transforms of the respective plural adjusted Fourier coefficient vectors to obtain plural inverse transformed data;
calculating an information criterion of each of the plural inverse transformed data; and
judging whether a spectrum of the period of the set value is included in the Fourier coefficient vector corresponding to the inverse transformed data whose information criterion is smallest or minimum.

11. A periodicity judgment program for judging periodicity of time series data, which makes a computer execute the steps of:
performing a Fourier transform of the time series data to obtain a Fourier coefficient vector;
performing a simplification adjustment on the Fourier coefficient vector corresponding to the time series data by removing at least a part of Fourier coefficients included in the Fourier coefficient vector to obtain plural adjusted Fourier coefficient vectors different in adjustment level according to degree of simplification;
performing inverse Fourier transforms of the respective plural adjusted Fourier coefficient vectors to obtain plural inverse transformed data;
calculating an information criterion of each of the plural inverse transformed data; and
judging whether a spectrum of the period of the set value is included in the Fourier coefficient vector corresponding to the inverse transformed data whose information criterion is smallest or minimum.
